(19) United States
(12) Patent Application Publication
(10) Pub. No.: US 2009/0241983 A1
(43) Pub. Date: Oct. 1, 2009

(54) Abrasive Dental Floss and Method of Making Same

(75) Inventors: Charles T. Williams, Bristol, PA (US); Kimberly E. Hill, Painted Post, NY (US)

Correspondence Address: HOLLAND & HART, LLP, P.O BOX 8749, DENVER, CO, 80201, US

(73) Assignee: COLTEC INDUSTRIES INC., Charlotte, NC (US)

(21) Appl. No.: 12/057,058

(22) Filed: Mar. 27, 2008

(51) Int. Cl. A61C 15/04; B32B 19/00

(52) U.S. Cl. 132/321; 428/357

(57) ABSTRACT

Polytetrafluoroethylene (PTFE) flosses have abrasives added to the floss fiber that increase the abrasion to teeth surfaces, and thus result in a floss that provides enhanced cleaning of surfaces of teeth that face interstices between teeth. Floss fiber is formed by loading a PTFE resin with an abrasive filler. The PTFE resin and filler are processed to form a floss fiber with a surface that provide enhanced abrasion properties.

### FIELD OF THE INVENTION

The present disclosure relates to dental floss, and more particularly dental floss made of polytetrafluoroethylene (PTFE) fibers that has abrasive components that facilitate cleaning of teeth.

### BACKGROUND OF THE INVENTION

Dental floss has been known for many years, and is used to clean the interstitial spaces between a person's teeth. Dental floss in more recent times has been formed from PTFE, which provides a fiber that is thin enough to be inserted between teeth with relative ease, and is strong enough to provide a reliable flossing fiber. PTFE flosses have a number of advantages over conventional nylon flosses, including resistance to shredding (and its accompanying sticking of fiber shreds between teeth) and high lubricity. PTFE floss materials are traditionally formed from a thin, flat tape slit into single filament strands that may be folded prior to the spooling process.

Such PTFE dental floss is characterized by a relatively smooth surface. Such a smooth surface is the result of the process used to form the floss, and results in relatively little abrasion relative to the surfaces of the teeth that are contacted by the floss. The smooth surface also results in a floss that may be difficult for some users to grasp.

### SUMMARY OF THE INVENTION

Certain embodiments of the present disclosure provide a dental floss having a length, width, and thickness, comprising a polytetrafluoroethylene (PTFE) fiber having substantially uniform dimensions of width and thickness along its length. The PTFE fiber has an outer surface of substantially rectangular cross-sectional dimension, and a significant portion of the surface area of the outer surface comprises an abrasive material. Such an abrasive material facilitates the cleaning of dental interstices, and may also provide enhanced grip. The dental floss, in some embodiments, has a width of at least 0.075 inches and the thickness of at least 0.0018 inches. The abrasive material may comprise particles that are embedded into the PTFE fiber, the particles having a particle diameter of at least 8.0 μm. The particles also may have a particle diameter of less than about 13 μm. The abrasive material may be an inorganic filler such as silica and/or alumina. The PTFE material may comprise processed homopolymers of PTFE resin that has a specific gravity of 2.148 to 2.164. The PTFE resin, in certain embodiments, is loaded with about 5%, by weight, of the abrasive material prior to processing. The floss may also incorporate one or more active ingredients selected from the group consisting of an anti-microbial, antibiotic, antibacterial agents, antifungal, dentifrice, remineralizing agents, whitening agents, immunological agents, anti-tartar, anti-caries agents, anti-plaque agents, lysozmes, anti-inflammatory agents, hemostatic agents, analgesics. The floss, in certain embodiments has a specific gravity of about 0.8 to about 1.0, and a tensile strength of about 1.8 to about 6.7 lb-f.

Other embodiments of the present disclosure provide a dental floss comprising a polytetrafluoroethylene (PTFE) fiber comprising expanded PTFE resin and abrasive filler, the abrasive filler comprising at least 5% of the formulation of the floss. In certain embodiments, the floss has a width of at least 1905 μm and a thickness of at least 45.7 μm. The abrasive filler may be particles of alumina and/or silica that have a particle diameter of about 8.0 μm to about 13.0 μm. The PTFE resin, in some embodiments, comprises homopolymers of PTFE having a specific gravity of 2.148 to 2.164.

Further embodiments of the present disclosure provide methods for producing a dental floss fiber. Such methods may comprise: (a) providing a polytetrafluoroethylene (PTFE) resin; (b) loading the PTFE resin with an abrasive filler; (c) blending the loaded PTFE resin with a lubricant to form a compound; (d) compressing the compound into a billet; (e) extruding the billet through a gap die to form a coherent extrudate; (f) compressing the coherent extrudate to a predetermined thickness; (g) removing the lubricant; and (h) stretching the coherent extrudate at a ratio of 10:1 to 50:1 at a temperature of 600° F. to 955° F. to form a floss fiber. The providing a PTFE resin may comprise providing a homopolymer PTFE resin having a specific gravity of about 2.148 to about 2.164. The loading of the PTFE resin with an abrasive filler may comprise providing an alumina filler powder having a particle diameter of about 8.0 μm to about 13.0 μm; and blending the alumina filler with the PTFE resin. The stretching the coherent extrudate may comprise stretching the coherent extrudate uniaxially in the longitudinal direction to a ratio of 25:1 of the original width, by passing the extrudate through an oven at a temperature of 650° F. to form a floss fiber.

It is to be understood that this Summary of the Invention lists various aspects of the present invention or various embodiments. Additional aspects will become apparent as this specification proceeds.

It is also to be understood that all features noted above need not be included in a given embodiment in order for the embodiment to fall within the scope of the present invention. In addition, not all deficiencies noted in the prior art need be overcome by a given embodiment in order for it to fall within the scope of the present invention.

### BRIEF DESCRIPTION OF THE DRAWINGS

FIG. 1 is a perspective illustration of a section of a floss fiber of an embodiment described herein.

### DETAILED DESCRIPTION

The inventors of the present disclosure have recognized that traditional polytetrafluoroethylene (PTFE) floss, while working well for the intended purpose of providing a safe, reliable, and strong fiber for flossing teeth, could be further enhanced if the floss were more effective for cleaning the surfaces of teeth that face the interstitial spaces between teeth. This is because the smooth nature of PTFE flosses results in a surface of the floss that has relatively little abrasion with the surfaces of teeth, thereby making traditional floss effective for removing debris from between teeth, but doing relatively little to abrade material off of a tooth surface. The present disclosure provides PTFE flosses that have abrasives added to the floss fiber that increase the abrasion to teeth surfaces, and thus result in a floss that provides enhanced cleaning of surfaces of teeth that face interstices between teeth.

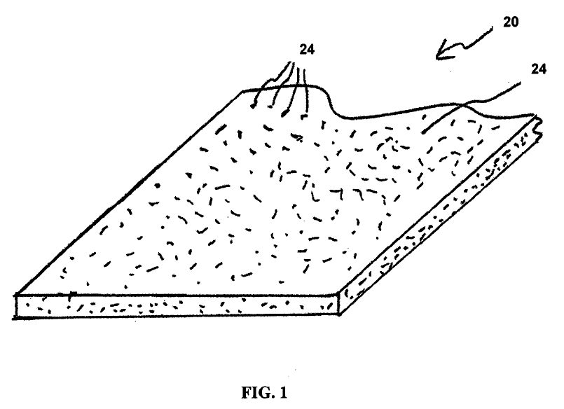

Referring now to FIG. 1, the dental floss 20 of the present disclosure is a film extrudate that comprises an oriented PTFE resin fiber 24 and abrasive fillers 28. The floss 20 of this embodiment comprises a single strand of expanded PTFE fiber that is essentially rectangular to oblong in cross-sectional dimensions and may be formed with or without folds or creases. The abrasive fillers 28 of the dental floss 20 promote abrasion for abrasive cleaning of dental interstices. In one embodiment, about 5 wgt % of the formulation of the dental floss 20 comprises abrasive fillers 28. In other embodiments, the formulation of the dental floss 20 that has abrasive fillers 28 ranges from 3% to 10% of the formulation weight. Various embodiments of the present disclosure may be prepared by any number of known processes, for example, by stretching or drawing processes, by papermaking processes, or by powder sintering processes. Such known processes generally begin with PTFE polymers. The term “polymers” as used herein, and understood by those of skill in the art, refers to materials, or combinations of materials, such as, homo- and co-fluoropolymers, to name but a two examples. The term “dental floss” as used herein refers to a thread-like material suitable for use in the cleaning of dental interstices. The terms filament and fiber may be used interchangeably with the term dental floss.

When forming the floss 20 with the abrasive fillers 28, the floss 20 strength is equivalent to that of existing flosses, and the floss thickness and width is equivalent to that of existing flosses. In various embodiments, the floss 20 width ranges from 600 μm to 3000 μm. In some embodiments, flosses may be folded to result in final products that have smaller widths. In various embodiments, the thickness of the floss 20 ranges from 33 μm to 300 μm. Again, in some embodiments, flosses may be folded to result in final products that have larger thicknesses. For example, a conventional PTFE floss fiber sold under the trademark EASY SLIDE by Johnson & Johnson has typical unfolded dimensions of about 33 μm in thickness and about 2.3 mm in width, with this material being spooled and packaged as dental floss. This floss fiber typically has a tensile strength of about 5.0 lb-f. Floss 20 of the present disclosure may be formed to have similar physical characteristics.

The floss 20 of the present invention is produced through a series of unique processing steps. First, a PTFE sheet formed. In one embodiment, a PTFE sheet is formed and slit into fibers of the present invention in the following manner. A fine powder PTFE resin is blended with a lubricant, such as odorless mineral spirits, until a compound is formed. The PTFE resin is selected such that the final floss both includes the abrasive filler and maintains a strength that is equivalent to existing PTFE flosses. In one embodiment, the resin comprises a fluoropolymer of PTFE having a specific gravity of 2.14 to 2.17, such as resin CD123 available from Asahi Glass and Chemicals, LTD, Tokyo Japan; resin FX9005 available from Daikin Industried, LTD, Osaka, Japan; and resin XPH260 available from Solvay S. A., Bruxelles, Belguim. An abrasive filler, such as silica or alumina, is added to the resin. The abrasive filler, in an embodiment, is added to the resin at 5% by weight, and has a particle size of 8 μm to 13 μm. The resin and filler are then blended with a lubricant, such as odorless mineral spirits, until a compound is formed. The volume of lubricant used should be sufficient to lubricate the primary particles of the PTFE resin so to minimize the potential of the shearing of the particles prior to extruding.

The compound is then compressed into a billet and extruded, such as through a ram type extruder, to form a coherent extrudate. The extrudate is then passed through a series of rollers then calenders that compress the extrudate to a desired thickness. The extrudate is also passed over one or more heated cans or plates to remove the lubricant. The dried extrudate is spooled into a “jumbo” to await further processing. The jumbo, in an embodiment, is approximately 229 mm in width, although this is but one example of a suitable width. A portion of the jumbo, then may be stretched in the longitudinal direction into a desired width, such as 2 inches (51 mm), at a specified temperature and ratio. The resulting web can then be slit to widths of 1397 μm to 2540 μm to form a flossing fiber. The stretching temperature may be from 600° F. to 955° F. (315° C. to 513° C.). The stretched fiber may then be wound onto a spool and shipped or stored for further processing.

51 The stretched fiber may be processed to include ingredients that a user of the floss may desire. Such ingredients may include, but are not limited to antioxidants, flavor impact agents, sodium fluoride, antimicrobials, antibiotics, antibacterial agents, antifungal agents, remineralizing agents, whitening agents, immunological agents, anti-tartar agents, anti-caries agents, anti-plaque agents, lysozmes, anti-inflammatory agents, homeostatic agents, analgesics, zinc chloride, tetrasodium pyrophosphate, sodium acid pyrophosphate, tetrapotassium pyrophosphate, vitamin K, water soluble calcium salts, blood factors that initiate the coagulation cascade, aminocaproic acid, tranexamic acid, adrenaline, alum, noradrenaline, iron salts and calcium alginate, sodium monofluorophosphate, stannous fluoride, chlorhexidine, hexachlorophene, cetyl pyridinium chloride, benzethonium chloride, ureases, calcium carbonate, magnesium carbonate, othophosphoric acid, monosodium phosphate, monopotassium phosphate, disodium phosphate, dipotassium phosphate, hemisodium phosphate, benzothonium, chloride, acetyl triemethyl ammonium bromide, sanguinaria, triclosan, tetracycline, cety pyridinium chloride, benzothonium chloride, melt emulsion of dimethicone and mixtures thereof. Other materials may be added as well such as natural flavor, natural oils and dyes, for example R-Carvone and trans Cinnamaldehyde.

The final dimensions of the fiber, in some embodiments, comprise: a width of about 1397 μm to 2540 μm; a thickness of about 33 μm to 102 μm; a density of about 0.70 to 1.0 g/cc; and a tensile strength of about 1.8 to 6.7 lb-f. These measurements may be made in any conventional manner. Width and thickness may be determined through any conventional means, such as through the use of micrometers or measurements through an optical gage. Density may be determined by dividing the measured weight of the sample by the computed volume of the sample. Bulk tensile strength may be measured by a tensile tester, such as an Instron™. The properties of a floss fiber made in accordance with the above procedures are comparable to properties of previous PTFE and expanded PTFE flosses, although the floss made in accordance with the above includes abrasive material.

Dental floss of various embodiments have enhanced abrasive properties, that may be described with respect to a roughness of the surface area of the floss. In some embodiments, surface roughness (Ra) is 0.8 μm to 1.2 μm. The surface roughness measurement Ra is a commonly used measurement that provides a description of the height variations in a surface. The surface roughness Ra is the arithmetic average of the absolute values of height deviations within the length of all the areas above and below a mean line parallel to the general surface direction.

Without intending to limit the scope of the present invention, the following examples illustrate how floss of the present disclosure may be made and used:

### Example 1

A fiber of the present invention was produced in the following manner.

A homopolymer PTFE fine powder resin was loaded to 5%, by weight, with the abrasive filler. The fine powder of homopolymer PTFE resin and abrasive filler were combined in a blender with an amount of lubricant (PD23 available from Brenntag Chemicals, Mülheim, Germany) until a uniform compound was obtained. The amount of lubricant used per pound of PTFE resin and filler was 22%. The homopolymer PTFE resin has a specific gravity of 2.148 to 2.164. The abrasive filler was alumina having a particle size ranging from 8 to 13 μm. The compound was compressed into a billet and extruded through a 1.4 mm gap die attached to a ram type extruder to form a coherent extrudate. A reduction ratio of 16 was used. The extrudate is passed over rollers and through calenders to compress the extrudate to a thickness of 254 μm and a width of 229 mm. The lubricant was volatilized and removed by passing the extrudate over a heat can at 350° F., and the dry extrudate was spooled into a jumbo. The extrudate was then stretched uniaxially at 760° F. in a thermal chamber in the longitudinal direction and at a ratio of 0.045 to 0.05 to form a floss fiber intermediate. The following measurements were taken on the finished fiber:
Width: 1905 μm
Thickness: 91 μm
Denier (g/9000 m): 1390
Density: 0.85 g/cc
Tensile strength: 5.4 lb-f
Tenacity: 1.76 g/denier
Average roughness Ra: 1.0 μm
Root Mean Square roughness Rq: 1.4 μm
Peak to Valley roughness Rt: 11.4 μm

### Example 2

A fiber of the present invention was produced in the following manner.

A homopolymer PTFE fine powder resin was loaded to 5%, by weight, with the abrasive filler. The fine powder of homopolymer PTFE resin and abrasive filler were combined in a blender with an amount of lubricant (PD23 available from Brenntag Chemicals, Mülheim, Germany) until a uniform compound was obtained. The amount of lubricant used per pound of PTFE resin and filler was 22%. The homopolymer PTFE resin has a specific gravity of 2.153. The abrasive filler was silica having a particle size ranging from 8 to 13 μm. The compound was compressed into a billet and extruded through a 1.4 mm gap die attached to a ram type extruder to form a coherent extrudate. A reduction ratio of 16 was used. The extrudate is passed over rollers and through calenders to compress the extrudate to a thickness of 254 μm and a width of 229 mm. The lubricant was volatilized and removed by passing the extrudate over a heat can at 350° F., and the dry extrudate was spooled into a jumbo. The extrudate was then stretched uniaxially at 650° F. in a thermal chamber in the longitudinal direction and at a ratio of 0.04 to form a floss fiber intermediate. The following measurements were taken on the finished fiber:
Width: 1905 μm
Thickness: 73 μm
Denier (g/9000 m): 1030
Density: 0.82 g/cc
Tensile strength: 4.3 lb-f
Tenacity: 1.89 g/denier
Average roughness Ra: 1.1 μm
Root Mean Square roughness Rq: 1.4 μm
Peak to Valley roughness Rt: 10.6 μm

The floss of the present disclosure has many improved properties over previous floss material. First, it has increased abrasion when passed over a surface of a tooth which, among other things, provides enhanced cleaning of teeth interstices. This is believed to produce a significantly better cleaning action than that possible with conventional flosses by physically abrading undesired material from the area of the teeth contacted by the floss. Second, the floss of the present invention exhibits an increased friction in the hand of a user, thus enhancing the “feel” of the floss. This property makes the floss easier to handle and more comfortable when a user is flossing between teeth.

While particular embodiments of the present invention have been illustrated and described herein, the present invention should not be limited to such illustrations and descriptions. It should be apparent that changes and modifications may be incorporated and embodied as part of the present invention within the scope of the following claims.

What is claimed is:

1. A dental floss having a length, width, and thickness, comprising:
a polytetrafluoroethylene (PTFE) fiber having substantially uniform dimensions of width and thickness along its length and having an outer surface of substantially rectangular cross-sectional dimension, and a significant portion of the surface area of the outer surface comprising an abrasive material.

2. The dental floss of claim 1 wherein the width of the floss is at least 600 μm and the thickness of the floss is at least 50 μm.

3. The dental floss of claim 1 wherein the abrasive material comprises particles that are embedded into the PTFE fiber, the particles having a particle diameter of at least 8.0 μm.

4. The dental floss of claim 3 wherein the particles have a particle diameter of less than about 13 ∞m.

5. The dental floss of claim 3, wherein the abrasive material comprises particles that are silica and/or alumina.

6. A dental floss of claim 1 wherein the floss incorporates at least one active ingredient.

7. The dental floss of claim 6 wherein the active ingredient is selected from the group consisting of at least one of an anti-microbial, antibiotic, antibacterial agents, antifungal, dentifrice, remineralizing agents, whitening agents, immunological agents, anti-tartar, anti-caries agents, anti-plaque agents, lysozmes, anti-inflammatory agents, hemostatic agents, analgesics.

8. The dental floss of claim 1 wherein the PTFE material comprises processed homopolymers of PTFE resin.

9. The dental floss of claim 8 wherein the PTFE resin has a specific gravity of 2.148 to 2.164.

10. The dental floss of claim 8, wherein the PTFE resin is loaded with about 5%, by weight, of the abrasive material prior to processing.

11. The dental floss of claim 1 wherein the floss has a specific gravity of about 0.8 to about 1.0.

12. The dental floss of claim 1 wherein the floss has a tensile strength of about 1.8 to about 6.7 lb-f.

13. A dental floss comprising
a polytetrafluoroethylene (PTFE) fiber comprising expanded PTFE resin and abrasive filler, the abrasive filler comprising at least 5% of the surface area of the floss.

14. The dental floss of claim 13 wherein the width of the floss is at least 600 μm and the thickness of the floss is at least 50 ∞m.

15. The dental floss of claim 13 wherein the abrasive material filler particles of alumina and/or silica that have a particle diameter of about 8.0 μm to about 13.0 μm.

16. A dental floss of claim 13 wherein the floss incorporates at least one active ingredient selected from the group consisting of at least one of an anti-microbial, antibiotic, antibacterial agents, antifungal, dentifrice, remineralizing agents, whitening agents, immunological agents, anti-tartar, anti-caries agents, anti-plaque agents, lysozmes, anti-inflammatory agents, hemostatic agents, analgesics.

17. The dental floss of claim 13 wherein the PTFE resin comprises homopolymers of PTFE having a specific gravity of 2.148 to 2.164.

18. The dental floss of claim 13 wherein the floss has a tensile strength of 1.8 to 6.7 lb-f.

19. The dental floss of claim 13 wherein the floss has a specific gravity of about 0.8 to about 1.0.

20. A method for producing a dental floss fiber, comprising:
providing a polytetrafluoroethylene (PTFE) resin;
loading the PTFE resin with an abrasive filler;
blending the loaded PTFE resin with a lubricant to form a compound;
compressing the compound into a billet;
extruding the billet through a gap die to form a coherent extrudate;
compressing the coherent extrudate to a predetermined thickness;
removing the lubricant; and
stretching the coherent extrudate at a ratio of 0.02 to 0.06 at a temperature of 600° F. to 955° F. to form a floss fiber.

21. The method of claim 20 further comprising:
adding at least one active ingredient to the floss fiber, the active ingredient(s) selected from the group consisting of at least one of an anti-microbial, antibiotic, antibacterial agents, antifungal, dentifrice, remineralizing agents, whitening agents, immunological agents, anti-tartar, anti-caries agents, anti-plaque agents, lysozmes, anti-inflammatory agents, hemostatic agents, analgesics.

22. The method of claim 20, wherein the providing a PTFE resin comprises providing a homopolymer PTFE resin having a specific gravity of about 2.148 to about 2.164.

23. The method of claim 20, wherein the loading the PTFE resin with an abrasive filler comprises:
providing an alumina filler powder having a particle diameter of about 8.0 μm to about 13.0 μm; and
blending the alumina filler with the PTFE resin.

24. The method of claim 20, wherein the stretching the coherent extrudate comprises:
stretching the coherent extrudate uniaxially in the longitudinal direction to a ratio of 0.042 of the original width, by passing the extrudate over a series of hot plates at a temperature of 650° F. to form a floss fiber.
